(19) United States
(12) Patent Application Publication
(10) Pub. No.: US 2012/0183696 A1
(43) Pub. Date: Jul. 19, 2012

(54) PLATING METHOD USING ANALYSIS PHOTORESIST RESIDUE IN PLATING SOLUTION

(76) Inventors: Jung-Dae Park, Ansan-si (KR); Seung-Ki Chae, Seoul (KR); Pil-Kwon Jun, Seoul (KR); Sung-Hoon Bae, Hwaseong-si (KR); Yoon-Mi Lee, Seoul (KR); Da-Hee Lee, Suwon-si (KR); Min-Jung Kim, Gyeyang-gu (KR)

(21) Appl. No.: 13/279,785

(22) Filed: Oct. 24, 2011

(30) Foreign Application Priority Data
Jan. 17, 2011 (KR) 10-2011-0004678

(51) Int. Cl. B05D 1/18; B05D 3/02; C25D 21/14

(52) U.S. Cl. 427/372.2; 205/81; 427/430.1

(57) ABSTRACT

A plating method includes supplying a plating solution into a plating bath, immersing a first substrate having a lower metal interconnection and a photoresist pattern in the plating solution, performing a first plating process and forming a first plating pattern on the first substrate, removing the first substrate from the plating solution, collecting a sample of the plating solution, analyzing a photoresist residue included in the sample, immersing a second substrate in the plating solution, and performing a second plating process and forming a second plating pattern on the second substrate.

### CROSS-REFERENCE TO RELATED APPLICATION

This application claims priority under 35 U.S.C. §119 to Korean Patent Application No. 10-2011-0004678 filed on Jan. 17, 2011, in the Korean Intellectual Property Office, and entitled, “Plating Method Using Analysis of Photoresist Residue in the Plating Solution,” is incorporated by reference herein in its entirety.

### BACKGROUND

1. Field

Embodiments relate to a plating method using an analysis of photoresist residue in a plating solution.

2. Description of Related Art

In a plating process of a semiconductor device, research into managing the life span of a plating solution and improving plating quality has been underway.

### SUMMARY

According to an embodiment, there is provided a plating method including supplying a plating solution into a plating bath, immersing a first substrate having a lower metal interconnection and a photoresist pattern in the plating solution, performing a first plating process and forming a first plating pattern on the first substrate, removing the first substrate from the plating solution, collecting a sample of the plating solution, analyzing a photoresist residue included in the sample, immersing a second substrate in the plating solution, and performing a second plating process and forming a second plating pattern on the second substrate.

The photoresist residue may include an acrylic resin or a decomposition product of the acrylic resin. Analyzing the photoresist residue may include analyzing for a content of one or more of the acrylic resin and the decomposition product of the acrylic resin in the photoresist residue.

The decomposition product of the acrylic resin may include ethyl cyclohexene, ethyl cyclopentene, methyl adamantane, ethyl adamantane or 4-hydroxy butyrolactone.

The analyzing of the photoresist residue may include analyzing the content of the photoresist residue included in the sample; and determining an exchange time for the plating solution based on the analyzed content of the photoresist residue.

The analyzing of the photoresist residue may include heating the sample, evaporating the photoresist residue, and analyzing the evaporated photoresist residue.

The method may further include adding salt to the sample before evaporating the photoresist residue. The salt may include sodium chloride (NaCl), potassium chloride (KCl), calcium chloride (CaCl₂), magnesium chloride (MgCl₂), or a combination thereof.

The heating of the sample may be performed at a temperature of about 60° C. to about 95° C.

The analyzing of the evaporated photoresist residue may include adsorbing the evaporated photoresist residue on an adsorbent, and analyzing the photoresist residue adsorbed on the adsorbent using a thermal desorption gas chromatography/mass spectrometry (TD-GC/MS) analysis method.

The adsorbing of the evaporated photoresist residue on the adsorbent may be performed using a quartz tube filled with the adsorbent, or a fiber coated with the adsorbent.

The TD-GC/MS analysis method may include desorbing the photoresist residue adsorbed on the adsorbent, and injecting the desorbed photoresist residue into a column.

The desorbing of the photoresist residue may include heating the adsorbent on which the photoresist residue is adsorbed at a temperature of about 200° C. to about 300° C.

The TD-GC/MS analysis method may include supplying a carrier gas of about 1.5 ml/min into the column, and controlling the column to raise the temperature by a predetermined temperature per minute from an initial temperature of about 40° C. to a final temperature of about 270° C.

The analyzing of the evaporated photoresist residue may be performed using a headspace gas chromatography/mass spectrometry (HS-GC/MS) analysis method, The HS-GC/MS analysis method may include injecting the evaporated photoresist residue into a column via a pipe heated to a temperature of 110° C. to 140° C.

According to an embodiment, there is provided a plating method including supplying a first plating solution into a plating bath, immersing a first substrate having a first lower metal interconnection and a first photoresist pattern in the first plating solution, the first photoresist pattern having an opening exposing the first lower metal interconnection, performing a first plating process and forming a first plating pattern on the first lower metal pattern exposed in the opening, removing the first substrate from the first plating solution, collecting a first sample of the first plating solution, analyzing a residue of the first photoresist pattern included in the first sample, performing at least one of exchanging, regenerating or supplementing the first plating solution to provide a second plating solution in the plating bath if the content of the photoresist residue in the sample exceeds the preset reference value and maintaining the first plating solution in the plating bath if the content of the photoresist residue in the sample does not exceed the preset reference value, immersing a second substrate in the plating bath, the plating bath including the first plating solution or the second plating bath according to whether the first plating solution is exchanged, regenerated or supplemented to provide the second plating solution or is maintained in the plating bath, and performing a second plating process and forming a second plating pattern on the second substrate.

The method may further include, after performing the second plating process, collecting a second sample of the second plating solution, analyzing a residue of the second photoresist pattern included in the second sample, and exchanging the second plating solution with a third plating solution.

According to an embodiment, there is provided a plating method including immersing a first substrate in a plating bath including a first plating solution, the first substrate including a photoresist pattern and a metal interconnection, performing a first plating process and forming a first plating pattern on the first substrate, removing the first substrate from the first plating solution, analyzing a sample of the first plating solution and determining whether a content of a photoresist residue in the sample exceeds the preset reference value, performing at least one of exchanging, regenerating or supplementing the first plating solution to provide a second plating solution in the plating bath if the content of the photoresist residue in the sample exceeds the preset reference value and maintaining the first plating solution in the plating bath if the content of the photoresist residue in the sample does not exceed the preset reference value, immersing a second substrate in the plating bath, the plating bath including the first plating solution or the second plating bath according to whether the first plating solution is exchanged, regenerated or supplemented to provide the second plating solution or is maintained in the plating bath, and performing a second plating process and forming a second plating pattern on the second substrate.

The photoresist pattern includes an acrylic resin. The analyzing of the sample of the first plating solution to determine whether a content of a photoresist residue in the sample exceeds the preset reference value may include determining whether a content of an acrylic resin or acrylic resin residue in the sample exceeds the preset reference value.

The acrylic resin of the photoresist pattern is an acrylic resin that decomposes to form at least one of ethyl cyclohexene, ethyl cyclopentene, methyl adamantane, ethyl adamantane or 4-hydroxy butyrolactone as a decomposition product, and the determining of whether the content of a photoresist residue in the sample exceeds the preset reference value includes determining whether a content of at least one of ethyl cyclohexene, ethyl cyclopentene, methyl adamantane, ethyl adamantane or 4-hydroxy butyrolactone exceeds the preset reference value.

### BRIEF DESCRIPTION OF THE DRAWINGS

The above and other features and advantages will become more apparent to those of ordinary skill in the art by describing in detail exemplary embodiments with reference to the attached drawings, in which:

The foregoing and other features will be apparent from the more particular description of preferred embodiments, as illustrated in the accompanying drawings in which like reference characters refer to the same parts throughout the different views. The drawings are not necessarily to scale. In the drawings:

FIG. 1A illustrates a block diagram of a plating system according to a first embodiment;

FIG. 1B illustrates a diagram of a photoresist residue adsorption device employed in a thermal desorption gas chromatography/mass spectrometry (TD-GC/MS) analysis method;

FIG. 1C illustrates a diagram of a photoresist residue desorption device employed in a TD-GC/MS analysis method;

FIG. 1D illustrates a diagram of a sample extraction module employed in a headspace gas chromatography/mass spectrometry (HS-GC/MS) analysis method;

FIGS. 1E and 1F illustrate flowcharts depicting a plating method according to the first embodiment;

FIG. 2 illustrates a chemical structure of an acrylic resin;

FIG. 3 illustrates an ethyl cyclohexene forming reaction mechanism;

FIGS. 4A and 4B illustrate chromatograms according to the Comparative Example;

FIGS. 5A to 5D illustrate chromatograms according to the First Experimental Example;

FIGS. 6A to 6G illustrate chromatograms according to the Second Experimental Example;

FIGS. 7A to 7C illustrate chromatograms according to the Third Experimental Example; and

FIGS. 8 to 11 illustrate cross-sectional views sequentially showing a method of fabricating a semiconductor device according to a second embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration.

Various embodiments will now be described more fully with reference to the accompanying drawings in which some embodiments are shown. This inventive concept may, however, be embodied in different forms and should not be construed as limited to the embodiments set forth herein. Rather, these embodiments are provided so that this disclosure is thorough and complete and fully conveys the scope thereof to one skilled in the art. In the drawings, the thickness of layers and regions may be exaggerated for clarity. Also, when a layer is referred to as “on” another layer or a substrate, it may be directly formed on another layer or the substrate or a third layer may be interposed therebetween. Like reference numerals designate like elements throughout the specification.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope thereof.

Unless otherwise defined, all terms (including technical and scientific terms) used herein have the same meaning as commonly understood by one of ordinary skill in the art to which the inventive concept belongs. It will be further understood that terms used herein should be interpreted as having a meaning that is consistent with their meaning in the context of this disclosure and the relevant art and will not be interpreted in an idealized or overly formal sense unless expressly so defined herein.

### First Embodiment

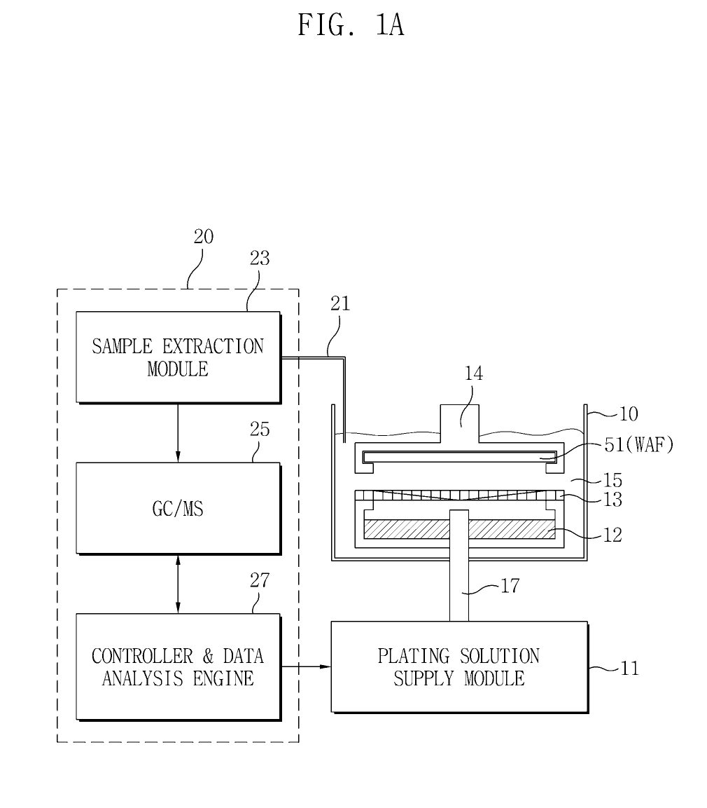

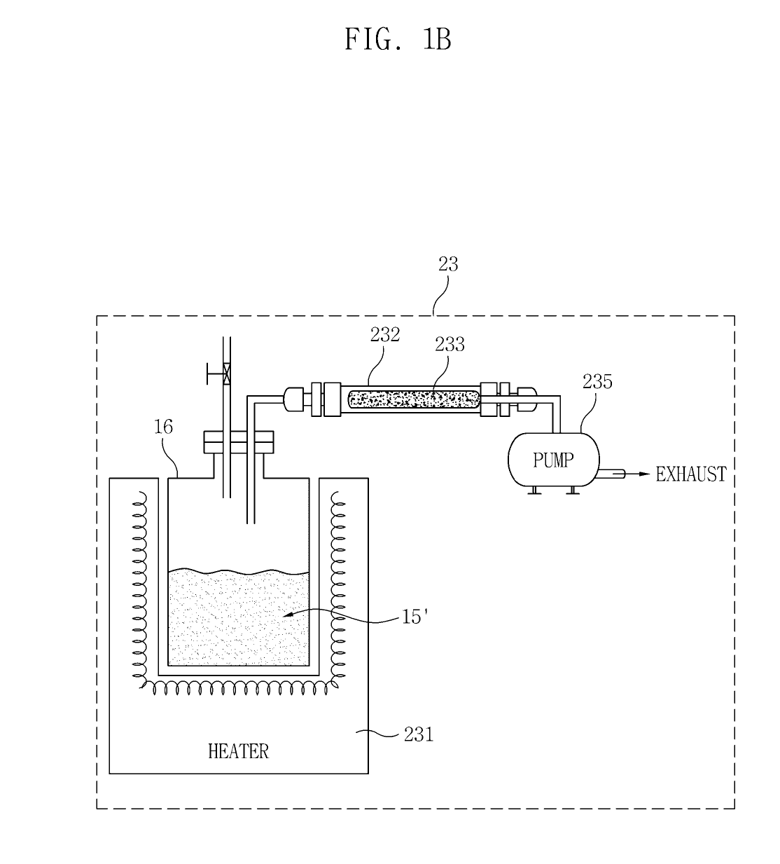

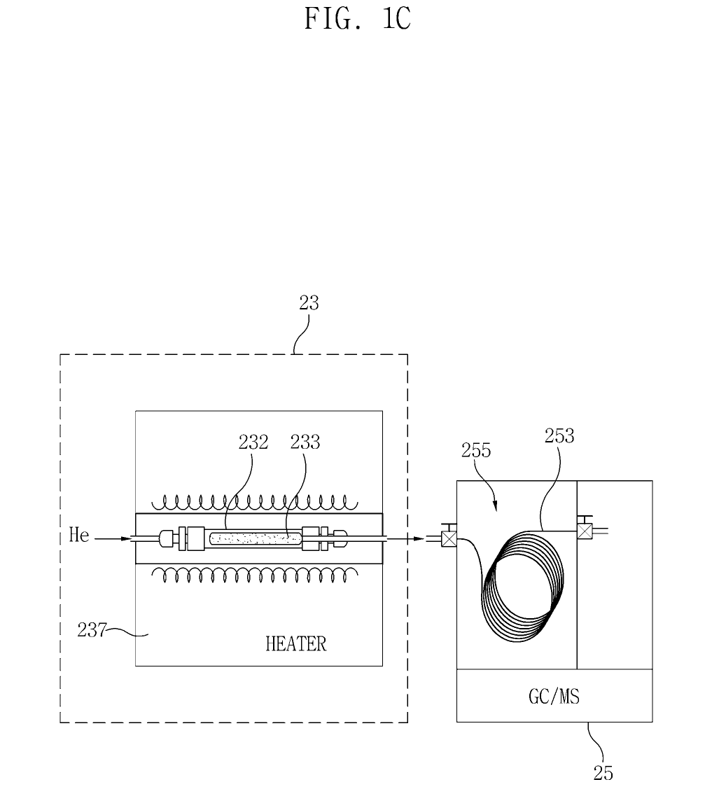

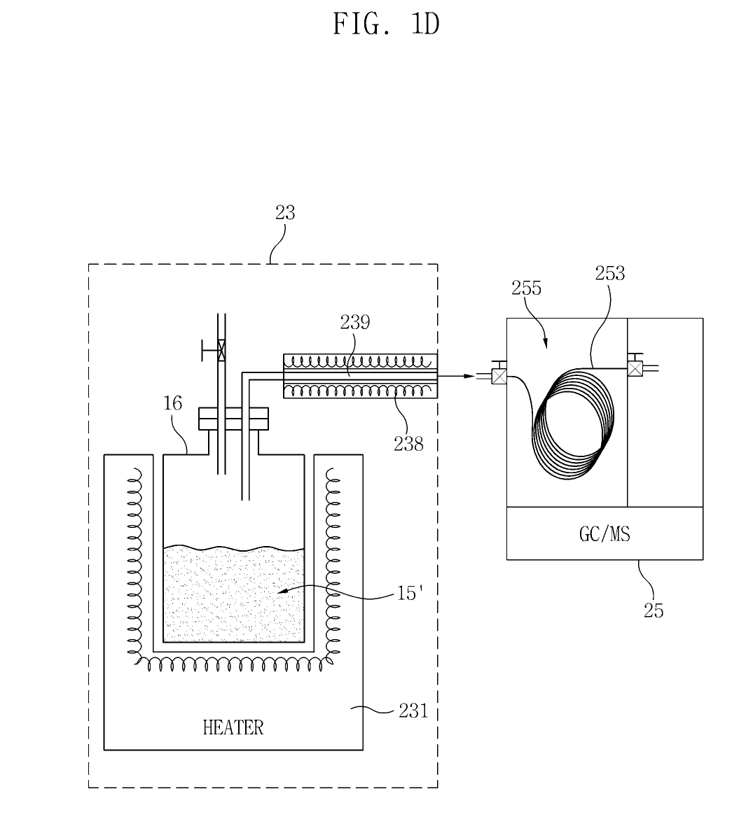

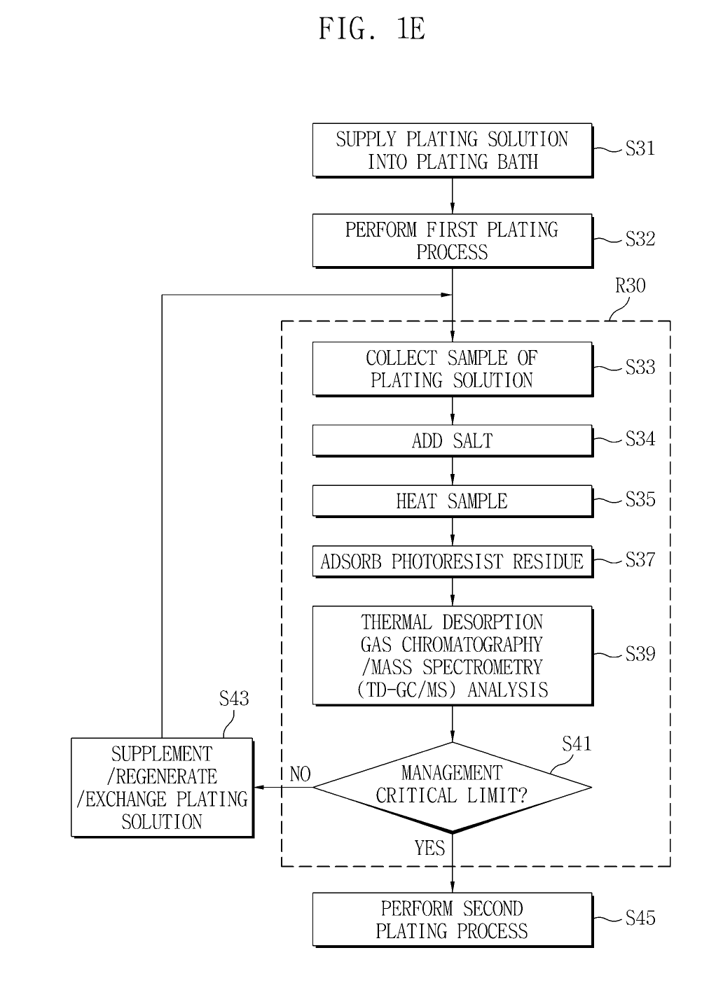

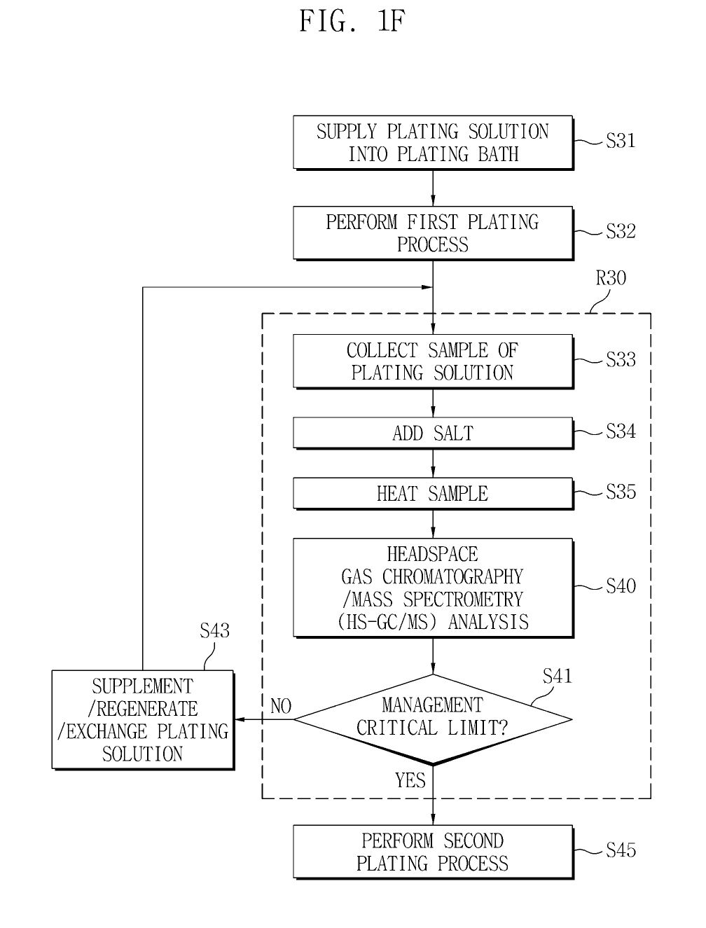

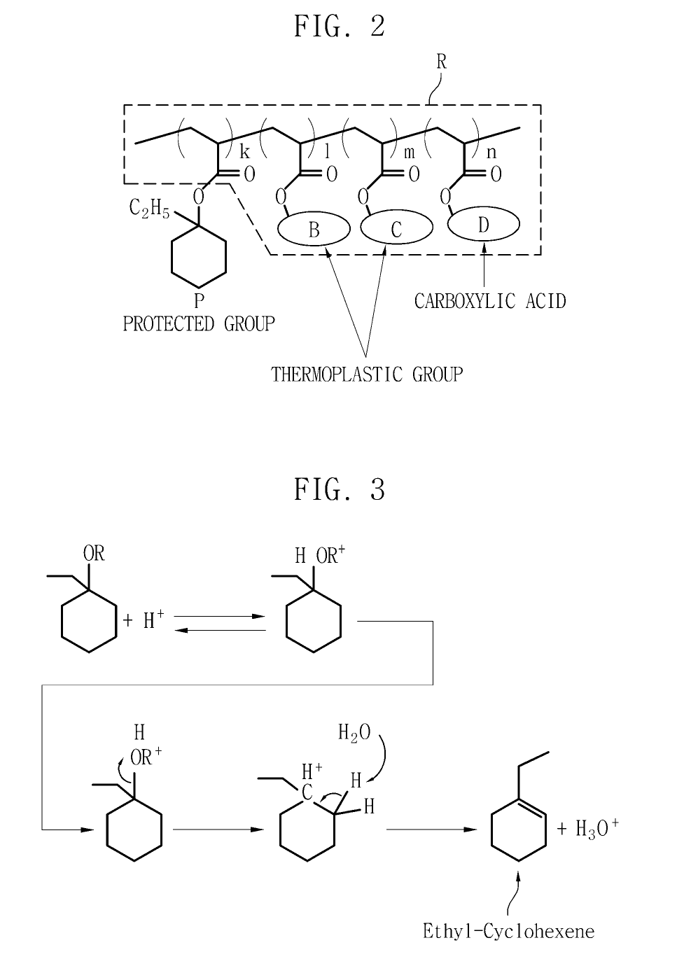

FIG. 1A illustrates a block diagram of a plating system according to a first embodiment, FIG. 2 illustrates a chemical structure of an acrylic resin, and FIG. 3 illustrates an ethyl cyclohexene forming reaction mechanism.

Referring to FIGS. 1A, 2 and 3, a plating system according to the first embodiment may include a plating bath 10 and an analysis system 20. A plating solution supply module 11 adjacent to the plating bath 10 may be provided. The plating solution supply module 11 may function to exchange/regenerate/supplement a plating solution 15 in the plating bath 10 via a first pipe 17.

The plating bath 10 may be an electroplating bath. A first electrode 12, a second electrode 14, and a diffuser 13 may be provided in the plating bath 10. A substrate 51 having a photoresist pattern (not shown) and a seed layer (not shown) may be mounted on the second electrode 14. The first electrode 12 may be an anode, and the second electrode 14 may be a cathode. The second electrode 14 may be electrically connected to the seed layer of the substrate 51. The diffuser 13 may be disposed between the first electrode 12 and the substrate 51. The substrate 51 may be immersed in the plating solution 15 during the plating process.

A photoresist residue may be generated from the photoresist pattern formed on the substrate 51 during the plating process, and thus the plating solution 15 may deteriorate. The content of the photoresist residue in the plating solution 15 may increase in proportion to the number and time of the plating processes. When the content of the photoresist residue in the plating solution 15 exceeds a reference value, the plating process may cause various types of defects. The photoresist residue may include an acrylic resin or a residue of the acrylic resin. In some embodiments, the photoresist residue may include ethyl cyclohexene, ethyl cyclopentene, methyl adamantine, ethyl adamantine, or 4-hydroxy butyrolactone. In this case, the photoresist residue may be interpreted as the acrylic resin or the acrylic resin residue.

For example, the photoresist pattern formed on the substrate 51 may include an acrylic resin having the same chemical structure as illustrated in FIG. 2. The acrylic resin may include a protected group (P), a thermoplastic group (B and C), and carboxylic acid (D). In the chemical structure of FIG. 2, each of k, l, m, and n may denote a positive integer. The reference character “R” in FIG. 3 may refer to the part of the chemical structure encompassed by the dashed line in FIG. 2. The acrylic resin may generate ethyl cyclohexene in the plating solution 15 by the reaction mechanism as illustrated in FIG. 3. The ethyl cyclohexene forming reaction mechanism illustrated in FIG. 3 may be interpreted as an acid catalytic hydrolysis reaction.

The analysis system 20 may include a sample extraction module 23, a gas chromatography (GC/MS) 25, and a controller and data analysis engine 27. The sample extraction module 23 may be in communication with the plating solution 15 in the plating bath 10 via a second pipe 21.

FIG. 1B is a diagram of a photoresist residue adsorption device of the sample extraction module 23 employed in a thermal desorption gas chromatography/mass spectrometry (TD-GC/MS) analysis method, and FIG. 1C is a diagram of a photoresist residue desorption device of the sample extraction module 23. FIG. 1D is a diagram of a sample extraction module 23 employed in a headspace gas chromatography/mass spectrometry (HS-GC/MS) analysis method.

Referring to FIGS. 1A to 1D, the analysis method using the analysis system 20 may be classified into the TD-GC/MS analysis method or the HS-GC/MS analysis method depending on the constitution of the sample extraction module 23. As illustrated in FIGS. 1B and 1C, the TD-GC/MS analysis method may employ a sample container 16, a first heater 231, a quartz tube 233, a pump 235 and a second heater 237. As illustrated in FIG. 1D, the HS-GC/MS analysis method may employ a sample container 16, a first heater 231, a third pipe 239, and a third heater 238.

[First Plating Method]

FIG. 1E is a flowchart illustrating a first plating method according to the first embodiment.

Referring to FIGS. 1A to 1C, and 1E, a first plating method according to the inventive concept may include supplying a first plating solution 15 into a plating bath 10 (S31), performing a first plating process using the first plating solution 15 (S32), confirming a state of the first plating solution 15 (R30), and performing a second plating process (S45).

Confirming the state of the first plating solution 15 (R30) may include collecting a first sample 15′ of the first plating solution 15 (S33), adding salt to the first sample 15′ (S34), heating the first sample 15′ (S35), adsorbing a photoresist residue (S37), analyzing the content of the photoresist residue using a TD-GC/MS analysis method (S39), and comparing the content of the photoresist residue with a management critical limit (S41). When the content of the photoresist residue exceeds the management critical limit, the first plating solution 15 may be exchanged/regenerated/supplemented (S43). When the content of the photoresist residue does not exceed the management critical limit, a second plating process may be performed (S45). The management critical limit may correspond to a preset value to prevent plating defects of the second plating process.

Specifically, the first plating solution 15 may include a metal and an electrolyte. The metal may include Cu, Sn, Ag, Ni, Au, or a combination thereof. The electrolyte may include sulfuric acid (H₂SO₄), methanesulfonic acid (MSA) (CH₃SO₂OH), hydrochloric acid (HCl), or a combination thereof. Also, the first plating solution 15 may optionally/additionally include plating characteristic adjusters such as an accelerator, a leveler and a suppressor. The first plating solution 15 may be supplied into the plating bath 10 by the plating solution providing module (11 of FIG. 1A) via the first pipe 17.

Performing the first plating process (S32) may include immersing a first substrate in the first plating solution 15, forming a first plating pattern on the first substrate, and taking the first substrate out from the first plating solution 15. Before immersing the first substrate, a first lower metal interconnection and a first photoresist pattern may be formed on the first substrate. The first photoresist pattern may include a first opening exposing the first lower metal interconnection. The first plating pattern may be formed on the first lower metal interconnection exposed in the first opening. As described above, during the first plating process, a residue of the first photoresist pattern may be generated in the first plating solution 15. The residue of the first photoresist pattern will be referred to as a “photoresist residue” below.

Collecting the first sample 15′ of the first plating solution 15 (S33) may be performed on-line using the second pipe 21. Alternatively, collecting the first sample 15′ of the first plating solution 15 (S33) may be performed off-line. For example, a small amount of the first sample 15′ of the first plating solution 15, e.g., between 5 ml and 50 ml, may be collected in a sample container 16 such as a vial.

For the purpose of accelerating evaporation of the photoresist residue, 0.1 g to 5 g of salt may be added to the first sample 15′ of the first plating solution 15 (S34). The salt may include sodium chloride (NaCl), potassium chloride (KCl), calcium chloride (CaCl₂), magnesium chloride (MgCl₂), or a combination thereof. In another embodiment, adding the salt to the first sample 15′ (S34) may be omitted.

As illustrated in FIG. 1B, the sample extraction module 23 may heat the first sample 15′ to evaporate the photoresist residue (S35). For example, the first sample 15′ in the sample container 16 may be heated using the first heater 231 at a temperature of 60° C. to 95° C. for 5 to 50 minutes. In this case, evaporation of the photoresist residue included in the first sample 15′ may be accelerated. The first heater 231 may include a hot plate or a heat jacket.

The evaporated photoresist residue may be adsorbed using the adsorbent 233 (S37). For example, as illustrated in FIG. 1B, an adsorbent 233 that fills the quartz tube 232 may be used. The adsorbent 233 may include a commercially available adsorbent such as Carbotrap (Sigma-Aldrich), Carbopack (Sigma-Aldrich) or Carbograph TD-1 having graphitized carbon, Carbosieve S-III, Carboxen 569 (Sigma-Aldrich), Carboxen 1000 (Sigma-Aldrich) or Spherocarb (Analabs) having a carbon molecular sieve, Chromosorb 102 (Johns-Manville) having styrene and divinylbenzene, Chromosorb 106 (Johns-Manville) having polystyrene, Porapak N (Waters Associates) having vinylpyrrolidone, Porapak Q (Waters Associates) having ethylvinylbenzene and divinylbenzene, Tenax TA (Buchem) having poly(diphenyl oxide) and Tenax GR (Buchem) having graphitized poly(diphenyl oxide). The adsorbents 233 are characterized by adsorbing an organic material such as the photoresist residue. One end of the quartz tube 232 may be connected to an exhaust pipe via the pump 235.

In some embodiments, adsorbing the evaporated photoresist residue (S37) may be performed using a fiber coated with the adsorbent 233.

Analyzing the content of the photoresist residue adsorbed on the adsorbent 233 (S39) may be performed using a TD-GC/MS analysis method. As illustrated in FIG. 1C, the sample extraction module 23 may include the second heater 237 for heating the adsorbent 233. The second heater 237 may include a hot plate or a heat jacket. The adsorbent 233 on which the photoresist residue is adsorbed, and the quartz tube 232 may be heated to a temperature of about 200° C. to about 300° C. using the second heater 237. While the adsorbent 233 and the quartz tube 232 are heated, helium (He) gas, nitrogen (N₂) gas or hydrogen (H₂) gas may be injected into the quartz tube 232. The photoresist residue may be desorbed from the adsorbent 233 to be injected into a column 253 of the GC/MS 25. The GC/MS 25 may perform quantitative/qualitative analysis on the desorbed photoresist residue.

For example, an HP-5MS column (60 m×320 mm×1 μm) (Agilent Technologies) may be used as the column 253 of the GC/MS 25. The column 253 may be disposed in an oven 255 of the GC/MS 25. The oven 255 may heat the column 253. In some Experimental Examples, the oven 255 may be controlled to raise the temperature by 10° C. per minute from an initial temperature of 40° C. to a final temperature of 270° C. In other embodiments, the oven 255 may be controlled to maintain an initial temperature of 40° C. for 10 minutes, and then, raise the temperature by 10° C. per minute to reach a final temperature of 270° C. In addition, while an analysis is carried out, a carrier gas of 1.5 ml/min may be supplied into the column 253. The carrier gas may include helium (He) gas, nitrogen (N₂) gas, hydrogen (H₂) gas, or a combination thereof. The GC/MS 25 may include a mass spectrometer. In some embodiments, the mass spectrometer may be connected to one end of the column 253. The photoresist residue may be desorbed from the adsorbent 233 to be injected into the mass spectrometer via the column 253. Conditions applied in the operation of the mass spectrometer include a mass range between 35 and 350 m/z, an ionization energy of 70 eV and a transfer line temperature of 250° C.

In other embodiments, an Elite-5MS column (60 m×320 mm×1 μm) PerkinElmer) may be used as the column 253.

Comparing the content of the photoresist residue in the first sample 15′ with the management critical limit (S41) may be conducted using the controller and data analysis engine 27. When the content of the photoresist residue included in the first sample 15′ does not exceed the management critical limit, a second plating process may be performed (S45).

The second plating process may be similar to the first plating process. For example, the second plating process may include immersing a second substrate into the first plating solution, forming a second plating pattern on the second substrate, and taking the second substrate out from the first plating solution. Before immersing the second substrate, a second lower metal interconnection and a second photoresist pattern may be formed on the second substrate. The second photoresist pattern may include a second opening exposing the second lower metal interconnection. The second plating pattern may be formed on the second lower metal interconnection exposed in the second opening.

When the content of the photoresist residue exceeds the management critical limit, the first plating solution 15 in the plating bath 10 may be exchanged/regenerated/supplemented using the plating solution providing module 11 (S43).

In some embodiments, when the content of the photoresist residue included in the first sample 15′ exceeds the management critical limit, such a result may be interpreted as an exchange time for the first plating solution 15. In this case, the first plating solution 15 may be exchanged with a second plating solution. Afterwards, a state of the second plating solution may be confirmed in a similar manner to the method of confirming that of the first plating solution 15 (R30). Here, when a new plating solution that is not used corresponds to the second plating solution, confirmation of the state of the second plating solution may be omitted. Then, a third plating process may be performed using the second plating solution.

The third plating process may be similar to the second plating process. For example, performing the third plating process may include immersing a third substrate in the second plating solution, forming a third plating pattern on the third substrate, and taking out the third substrate from the second plating solution. Before immersing the third substrate, a third lower metal interconnection and a third photoresist pattern may be formed on the third substrate. The third photoresist pattern may include a third opening exposing the third lower metal interconnection. The third plating pattern may be formed on the third lower metal interconnection exposed in the third opening.

After performing the third plating process, the state of the second plating solution may be confirmed in a similar method to that of confirming the state of the first plating solution 15 (R30). For example, confirming the state of the second plating solution may include collecting a second sample of the second plating solution, and analyzing the residue of the third photoresist pattern included in the second sample. The residue of the third photoresist pattern will be referred to as a photoresist residue below. When the content of the photoresist residue included in the second sample exceeds the management critical limit, the second plating solution may be exchanged with a third plating solution.

[Second Plating Method]

FIG. 1F illustrates a flowchart illustrating a second plating method according to the first embodiment.

Referring to FIGS. 1A, 1D and 1F, a second plating method according to the first embodiment may include supplying a first plating solution 15 into a plating bath 10 (S31), performing a first plating process using the first plating solution 15 (S32), confirming a state of the first plating solution 15 (R30), and performing a second plating process (S45).

Confirming the state of the first plating solution 15 (R30) may include collecting a first sample 15′ of the first plating solution 15 (S33), adding salt to the first sample 15′ (S34), heating the first sample 15′ (S35), analyzing the content of the photoresist residue using a headspace gas chromatography (HS-GC/MS) analysis method (S40), comparing the content of the photoresist residue with a management critical limit (S41), and exchanging/regenerating/supplementing the first plating solution 15 when the content of the photoresist residue exceeds the management critical limit (S43). When the content of the photoresist residue does not exceed the management critical limit, the second plating process may be performed (S45). Only differences will be briefly described below.

As illustrated in FIG. 1D, the first sample 15′ in the sample container 16 may be heated at a temperature of 60° C. to 95 C. for 5 to 50 minutes using the first heater 231. The evaporated photoresist residue may be injected into a column 253 of the GC/MS 25 via the third pipe 239. The third pipe 239 may be heated to a temperature of 110° C. to 140° C. using the third heater 238. The third heater 238 may include a hot plate or a heat jacket. For example, while the evaporated photoresist residue is injected into the column 253 via the third pipe 239, the third pipe 239 may be heated to a temperature of 120° C. using the third heater 238.

The content of photoresist residue included in a plating solution according to the first embodiment may be analyzed to efficiently manage the life span of the plating solution. Also, a method of analyzing various kinds of plating solutions may be simplified and standardized. Further, the state of using the plating solution may be promptly and exactly determined, so that an exchange time for a plating solution may be substantially lengthened, and plating defects may be prevented to significantly increase productivity of a plating process.

### Comparative Example

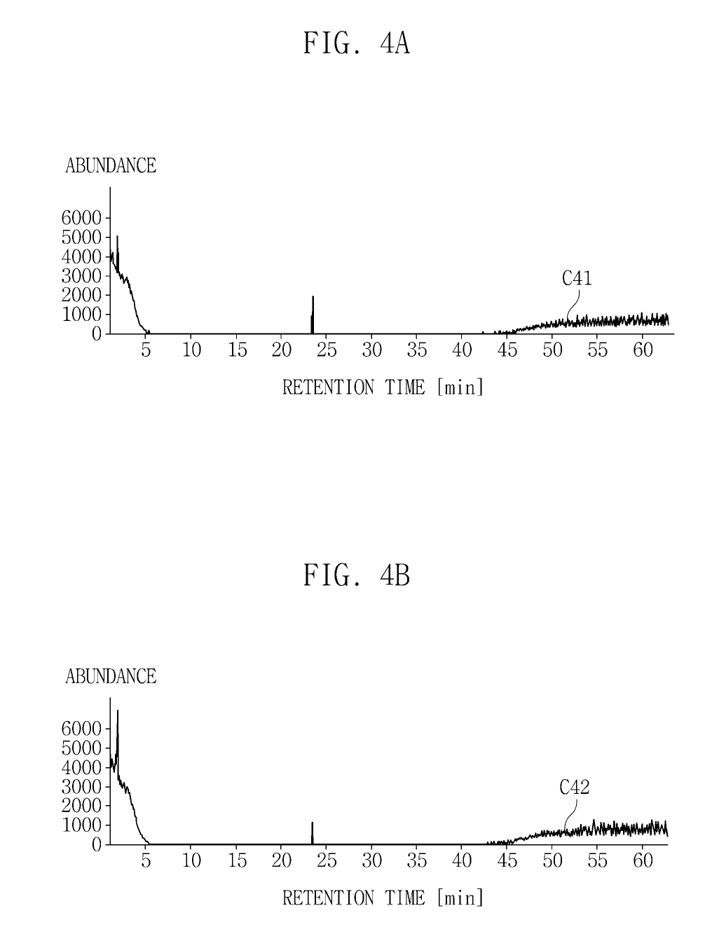

FIGS. 4A and 4B illustrate chromatograms according to Comparative Example. A retention time is plotted on a horizontal axis of FIGS. 4A and 4B in units of minutes. An abundance is plotted on a vertical axis of FIGS. 4A and 4B. Chromatogram C41 represents results of analyzing a sample 41 corresponding to a SnAg plating solution that has not been used, and Chromatogram C42 represents results of analyzing a sample 42 corresponding to a SnAg plating solution that is being used during a mass production process.

Referring to FIGS. 4A and 4B, a SnAg plating solution includes Sn, Ag, MSA (CH₃SO₂OH), a polyethylene glycol (PEG)-based additive, a dithione-based material and water (H₂O). The SnAg plating solution has high corrosive characteristics. The samples 41 and 42 were respectively diluted 10000 times with a CH₃OH solution to be analyzed using a Direct-GC/MS. As confirmed through Chromatograms C41 and C42, a peak estimated as a photoresist residue is not detected. Consequently, it is observed that it is difficult to detect the photoresist residue using the analysis method in which a plating solution is diluted and a Direct-GC/MS is used.

### First Experimental Example

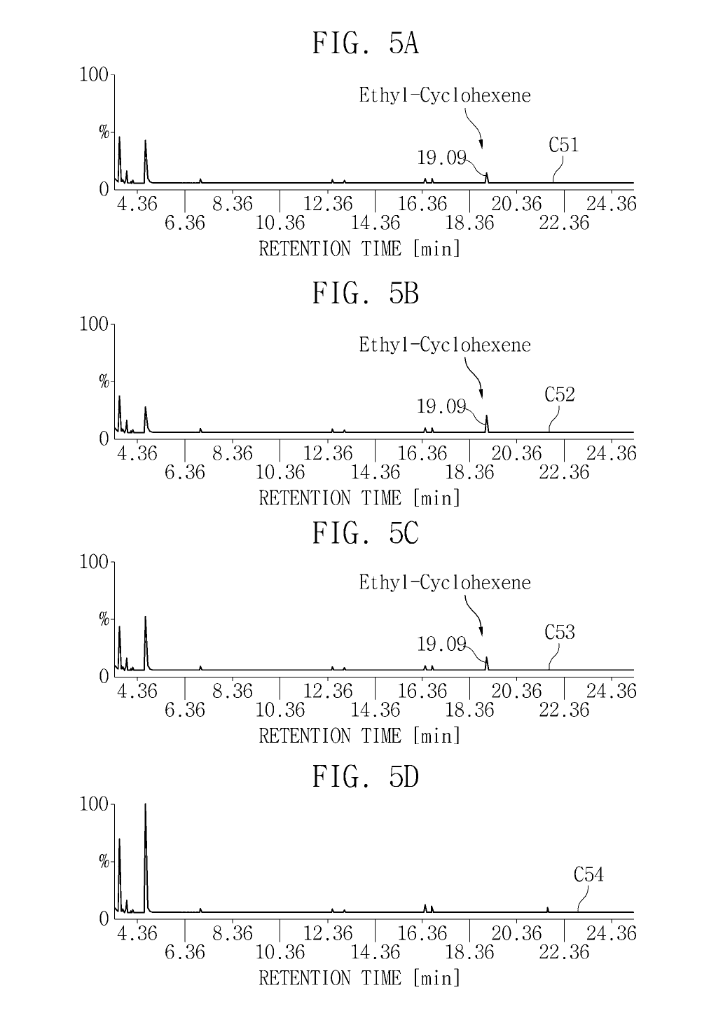

FIGS. 5A to 5D illustrate chromatograms according to First Experimental Example. A retention time is plotted on a horizontal axis of FIGS. 5A to 5D in units of minutes. A percentage (%) is plotted on a vertical axis of FIGS. 5A to 5D. Chromatograms C51 to C53 represent results of analyzing samples 51 to 53 corresponding to a SnAg plating solution that is being used during a mass production process, and Chromatogram C54 represents results of analyzing a sample 54 corresponding to a SnAg plating solution that is not used.

Referring to FIGS. 5A to 5D, Chromatograms C51 xto C54 were analyzed using a TD-GC/MS analysis method similar to that used in FIGS. 1B, 1C and 1E. Each of the samples 51 to 54 has a similar composition ratio to a mixture of 1000 ml of D.I. water, 75 g of Sn, 0.5 g of Ag, 250 g of MSA (CH₃SO₂OH), 100 ml of PEG-based additive and 10 ml of a dithione-based material. Salt was added to each of the samples 51 to 54 to accelerate the evaporation of the photoresist residue. Sodium chloride (NaCl) was used as the salt. 10 ml of plating solution and 2 g of NaCl were put in a 20 ml vial to prepare each of the samples 51 to 54.

Then, a photoresist residue adsorbing device having a similar constitution to that of FIG. 1B was used for heating at a temperature of 90° C., and adsorption was performed on the adsorbent 233 for 30 minutes. Afterwards, a TD-GC/MS analysis method having a similar constitution to that of FIG. 1C was employed to perform desorption and analysis of the photoresist residue. The desorption of the photoresist residue was performed by heating the photoresist residue to a temperature of 280° C. A column 253 used for the analysis was HP-5MS, and 1.5 ml/min of He was used as a carrier gas. The oven 255 was controlled to raise the temperature by 10° C. per minute from an initial temperature of 40° C. to a final temperature of 270° C. Conditions applied to the mass spectrometry included a mass range between 35 and 350 m/z, an ionization energy of 70 eV and a transfer line temperature of 250° C.

Different from Chromatogram C54, in Chromatograms C51 to C53, a peak is observed at a retention time of around 19.09 minutes. The peak at a retention time of around 19.09 minutes has been confirmed to be ethyl cyclohexene (CAS No. 1453-24-3), which is a residue of an acrylic resin. It is observed that the content of photoresist residue included in samples 51 to 53 may be analyzed by calculating an area of the peak.

### Second Experimental Example

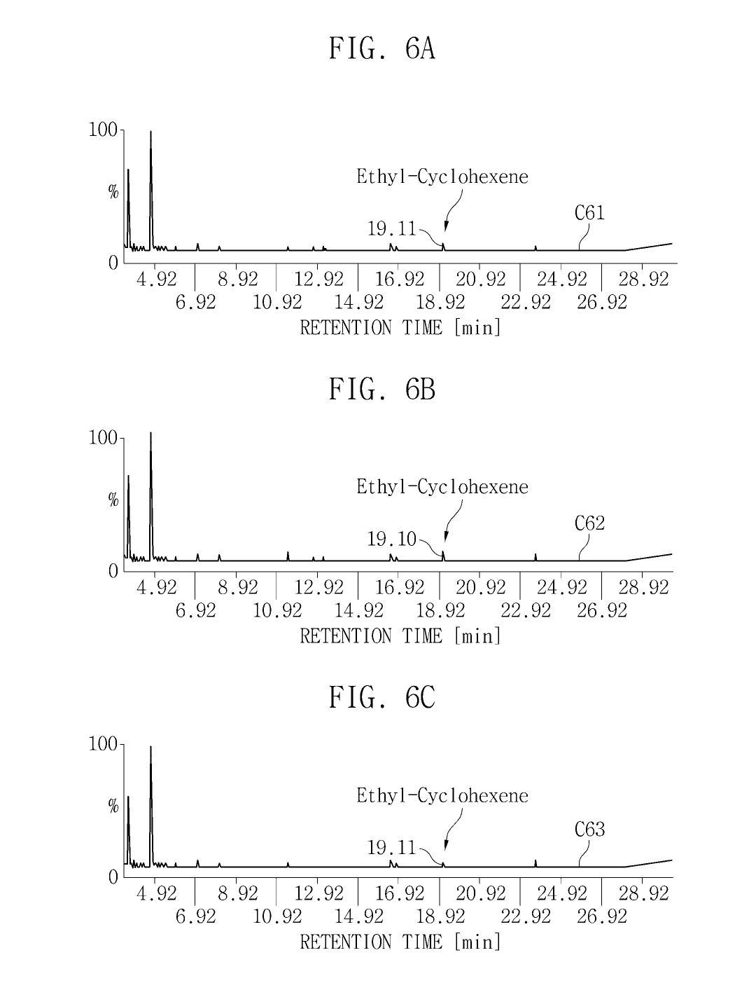

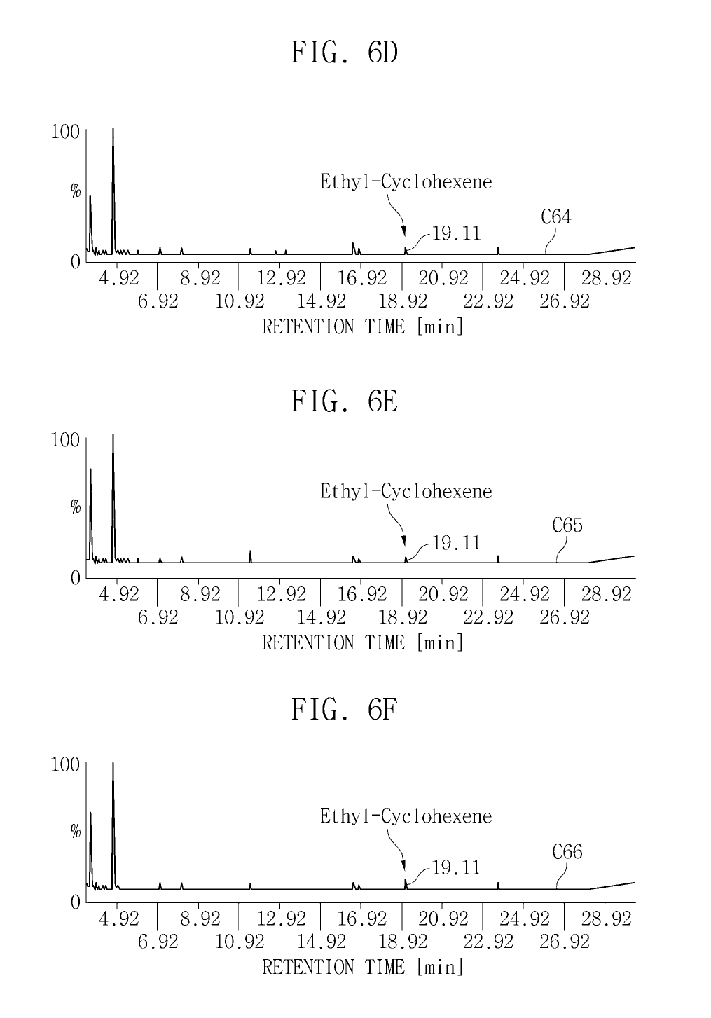

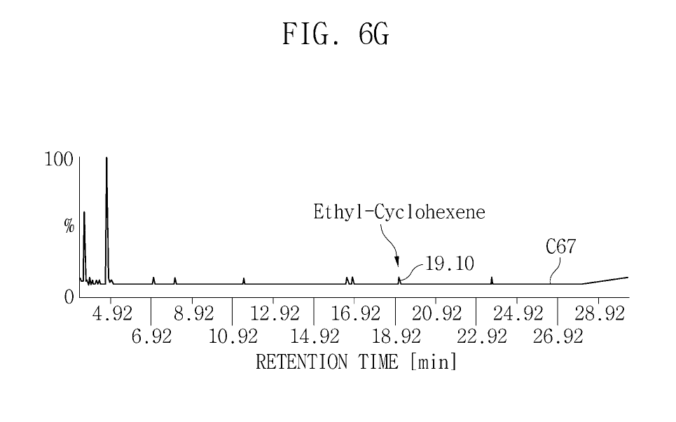

FIGS. 6A to 6G illustrate chromatograms according to Second Experimental Example. Chromatograms C61 to C67 are results of analyzing samples 61 to 67 corresponding to a SnAg plating solution that is being used during a mass production process.

Referring to FIGS. 6A to 6G, Chromatograms C61 to C67 were analyzed using a HS-GC/MS analysis method in a similar manner to that of FIGS. 1D to 1F. Each of the samples 61 to 67 has a similar composition ratio to a mixture of 1000 ml of D.I. Water, 75 g of Sn, 0.5 g of Ag, 250 g of MSA (CH₃SO₂OH), 100 ml of PEG-based additive and 10 ml of a dithione-based material. Salt was added to each of the samples 61 to 67 to accelerate the evaporation of photoresist residue. 10 ml of a SnAg plating solution being used during a mass production process and 2 g of NaCl were put in a 20 ml vial to prepare each of the samples 61 to 67.

Sequentially, a sample extraction module 23 having a similar constitution to that of FIG. 1D was used to perform an analysis using a HS-GC/MS analysis method. Specifically, the first heater 231 was used to heat the samples 61 to 67 to a temperature of 90° C. and inject the evaporated photoresist residue into the column 253 via the third pipe 239. The third pipe 239 was heated to a temperature of 120° C. using the third heater 238.

The column 253 used for analysis was an Elite-5MS, and a carrier gas was 1.5 ml/min of He. The oven 255 was controlled to raise the temperature by 10° C. per minute from an initial temperature of 40° C. to a final temperature of 270° C. Conditions applied to the mass spectrometry included a mass range between 35 and 350 m/z, an ionization energy of 70 eV and a transfer line temperature of 250° C.

In all of the Chromatograms C61 to C67, a peak is observed at a retention time of around 19.10 minutes or 19.11 minutes. The peak at a retention time of around 19.10 minutes or 19.11 minutes has been confirmed to be ethyl cyclohexene (CAS No. 1453-24-3), which is a residue of an acrylic resin. It is observed that the content of photoresist residue included in samples 61 to 67 may be analyzed by calculating an area of the peak.

### Third Experimental Example

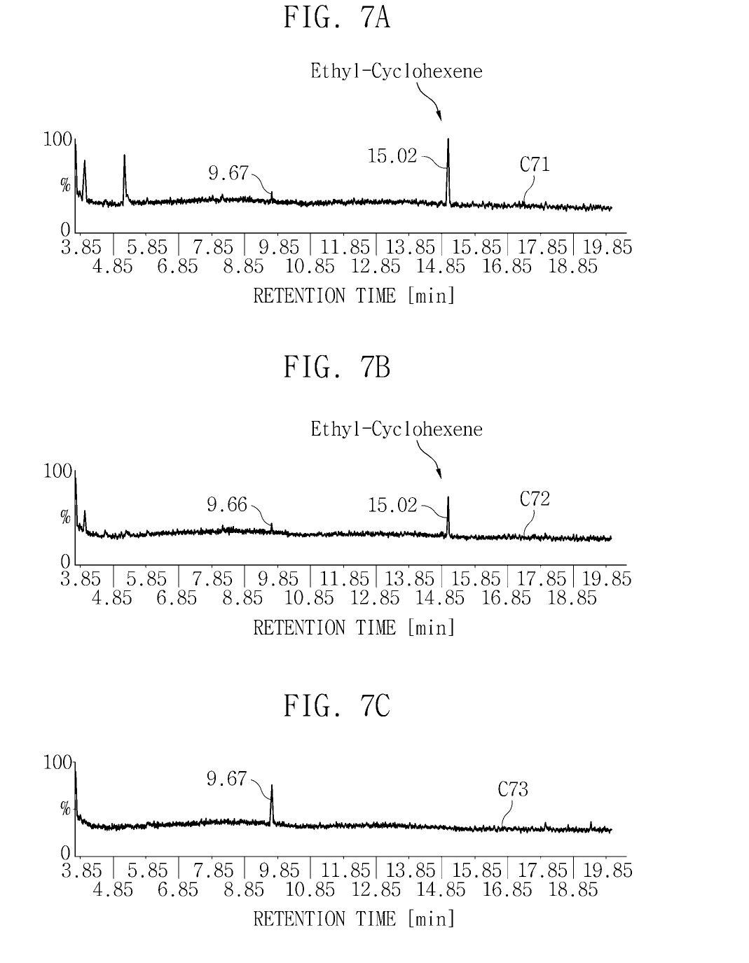

FIGS. 7A to 7C illustrate chromatograms according to Third Experimental Example. Chromatogram C71 is the result of analyzing a sample 71 corresponding to a Cu plating solution that was used for 14 days during a mass production process, Chromatogram C72 is the result of analyzing a sample 72 corresponding to a Cu plating solution that was used for 7 days during a mass production process, and Chromatogram C73 is the result of analyzing a sample 73 corresponding to a Cu plating solution that was not used.

Referring to FIGS. 7A to 7C, different from Chromatogram C73, in Chromatograms C71 to C72, a peak is observed at a retention time of around 15.02 minutes. The peak appearing at a retention time of around 15.02 minutes has been confirmed to be ethyl cyclohexene (CAS No. 1453-24-3), which is a residue of an acrylic resin.

The intensity of the peak for ethyl cyclohexene appearing in Chromatogram C71 is calculated as 4135955.08, and the intensity of the peak for ethyl cyclohexene appearing in Chromatogram C72 is calculated as 1246718.40. The intensity may be obtained by calculating an area of the peak, and the content of photoresist residue included in each of the samples 71 and 72 may be analyzed using the intensity. It is observed that the content of the photoresist residue in the Cu plating solution increases in proportion to the period of mass production in Chromatograms C71 to C72.

### Second Embodiment

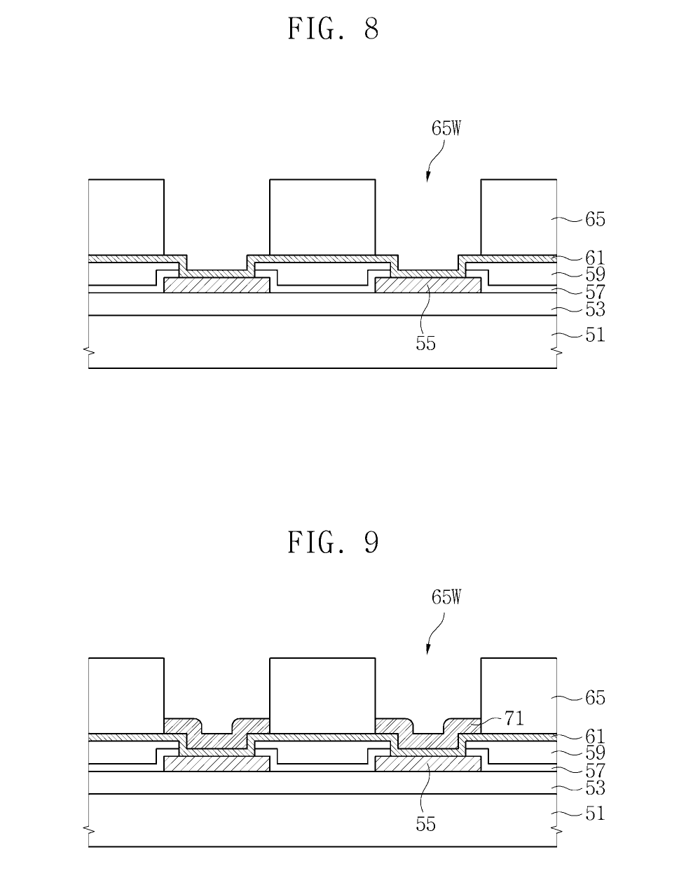

FIGS. 8 to 11 illustrate cross-sectional views illustrating a method of fabricating a semiconductor device according to a second embodiment.

Referring to FIGS. 1A, 1F and 8, the substrate 51 may be immersed in the plating bath 10 filled with the first plating solution 15. An interlayer insulating layer 53, a lower metal pattern 55, a first insulating layer 57, a second insulating layer 59, a seed layer 61 and a photoresist pattern 65 may be formed on the substrate 51. The photoresist pattern 65 may include an opening 65W aligned on the lower metal pattern 55.

The substrate 51 may be a semiconductor substrate such as a single crystalline silicon wafer. The interlayer insulating layer 53 may cover the substrate 51. The interlayer insulating layer 53 may include a silicon oxide layer, a silicon nitride layer, a silicon oxynitride layer, or a combination thereof. The lower metal pattern 55 may be formed on the interlayer insulating layer 53. The lower metal pattern 55 may be formed of a chip pad, a redistribution pattern or an end of a through electrode. The first insulating layer 57 and the second insulating layer 59 may be sequentially stacked on the interlayer insulating layer 53. The first insulating layer 57 and the second insulating layer 59 may cover edges of the lower metal pattern 55. For example, the first insulating layer 57 may be a passivation layer, and the second insulating layer 59 may be a polyimide layer.

The seed layer 61 may cover the substrate 51. The seed layer 61 may be in contact with the lower metal pattern 55. The seed layer 61 may include a Ti layer, a TiN layer, a Ta layer, a TaN layer, a Cu layer, a conductive carbon (C) layer, or a combination thereof. For example, the seed layer 61 may be formed of a stacked layer of a Ti layer/a TiN layer/a Cu layer.

The photoresist pattern 65 may cover the seed layer 61. The seed layer 61 may be exposed in the opening 65W. The photoresist pattern 65 may include an acrylic resin. The first plating solution 15 may include Cu.

Referring to FIG. 9, a first plating process may be used to form a first plating pattern 71 on the seed layer 61 in the opening 65W. The substrate 51 having the first plating pattern 71 may be taken out from the first plating solution 15. Then, analysis of the content of the photoresist residue may be performed. The process of analyzing the content of the photoresist residue may be understood with reference to FIGS. 1A to 1F.

In some embodiments, the first plating pattern 71 may be a Cu layer. The first plating pattern 71 may be formed on the seed layer 61 in the opening 65W.

In other embodiments, the substrate 51 may correspond to a first substrate. When the content of the photoresist residue does not exceed a management critical limit, a second plating process may be performed to form a second plating pattern on a second substrate. The second substrate and the second plating pattern may exhibit a similar constitution to the substrate 51 and the first plating pattern 71.

In still other embodiments, when the content of the photoresist residue exceeds the management critical limit, the first plating solution 15 may be exchanged with a second plating solution. The second plating solution may be used to perform a third plating process, so that a third plating pattern may be formed on a third substrate. The third substrate and the third plating pattern may exhibit a similar constitution to the substrate 51 and the first plating pattern 71.

After performing the third plating process, analysis of the content of the photoresist residue may be performed once again. The process of analyzing the content of the photoresist residue may be understood with reference to FIGS. 1A to 1F. When the content of the photoresist residue exceeds the management critical limit, the second plating solution may be exchanged with a third plating solution.

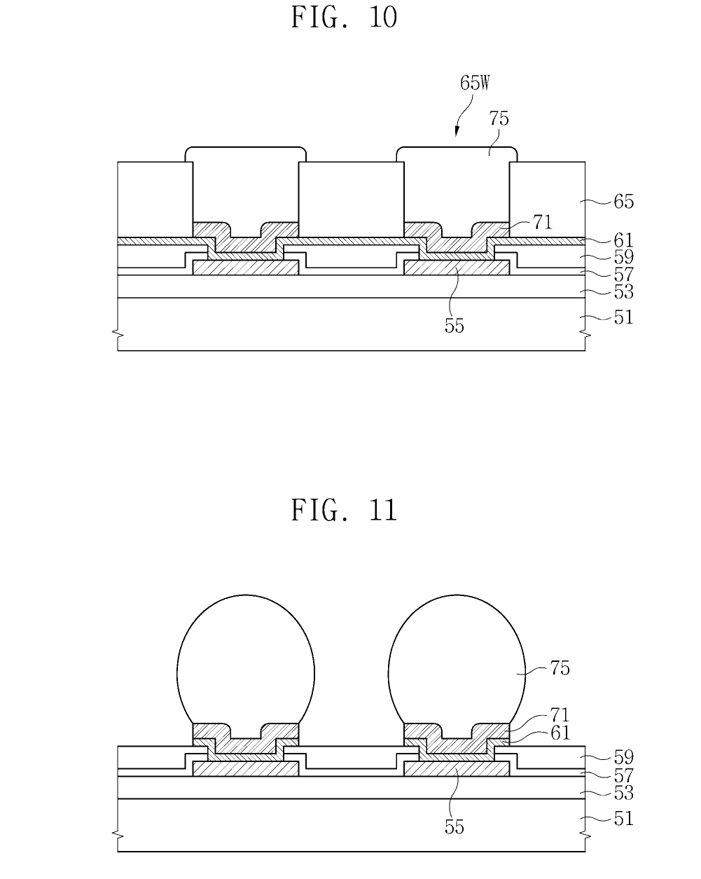

Referring to FIG. 10, a fourth plating process may be used to form a fourth plating pattern 75 on the first plating pattern 71. The fourth plating pattern 75 may be a SnAg layer. The fourth plating pattern 75 may fill the opening 65W.

Specifically, the substrate 51 having the first plating pattern 71 may be immersed in the plating bath 10 filled with a fourth plating solution. The fourth plating solution may exhibit different compositions from the first plating solution 15. The fourth plating solution may include Sn and Ag. The substrate 51 having the fourth plating pattern 75 may be taken out from the fourth plating solution.

Afterwards, analysis of the content of photoresist residue may be performed. The process of analyzing the content of the photoresist residue may be understood with reference to FIGS. 1A to 1F. When the content of the photoresist residue does not exceed the management critical limit, a fifth plating process may be performed to form a fifth plating pattern on the second substrate. The fifth plating pattern may exhibit a similar constitution to the fourth plating pattern 75.

In other embodiments, when the content of the photoresist residue exceeds the management critical limit, the fourth plating solution may be exchanged with a fifth plating solution. The fifth plating solution may be used to perform a sixth plating process to form a sixth plating pattern on the third substrate. The sixth plating pattern may have a similar constitution to the fourth plating pattern 75 as well.

After performing the sixth plating process, analysis of the content of the photoresist residue may be performed once again. The process of analyzing the content of the photoresist residue may be understood with reference to FIGS. 1A to 1F. When the content of the photoresist residue exceeds the management critical limit, the fifth plating solution may be exchanged with a sixth plating solution.

Referring to FIG. 11, the photoresist pattern 65 may be removed. Then, the seed layer 61 may be etched back. In this case, the seed layer 61 may remain below the first plating pattern 71. The seed layer 61 may function as a barrier metal layer. Further, a reflow process may be used to modify the fourth plating pattern 75 to be round. In this case, the fourth plating pattern 75 may be referred to as a bump, and the first plating pattern 71 may be referred to as an under bump metallurgy (UBM) or a ball limiting metallurgy (BLM).

According to the embodiments described herein, a plating method including analyzing the content of a photoresist residue included in a plating solution, and continuously using the plating solution or exchanging the plating solution with another plating solution according to the analyzed results is provided. The method may standardize the life span of plating solutions. Further, mass production efficiency of a plating process may be significantly improved.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plating method, comprising:
supplying a plating solution into a plating bath;
immersing a first substrate having a lower metal interconnection and a photoresist pattern in the plating solution;
performing a first plating process and forming a first plating pattern on the first substrate;
removing the first substrate from the plating solution;
collecting a sample of the plating solution;
analyzing a photoresist residue included in the sample;
immersing a second substrate in the plating solution; and
performing a second plating process and for ning a second plating pattern on the second substrate.

2. The method as claimed in claim 1, wherein:
the photoresist residue includes an acrylic resin or a decomposition product of the acrylic resin, and
analyzing the photoresist residue includes analyzing for a content of one or more of the acrylic resin and the decomposition product of the acrylic resin in the photoresist residue.

3. The method as claimed in claim 2, wherein the decomposition product of the acrylic resin includes ethyl cyclohexene, ethyl cyclopentene, methyl adamantane, ethyl adamantane or 4-hydroxy butyrolactone.

4. The method as claimed in claim 1, wherein the analyzing of the photoresist residue includes:
analyzing the content of the photoresist residue included in the sample; and
determining an exchange time for the plating solution based on the analyzed content of the photoresist residue.

5. The method as claimed in claim 1, wherein the analyzing of the photoresist residue includes:
heating the sample, evaporating the photoresist residue; and
analyzing the evaporated photoresist residue.

6. The method as claimed in claim 5, further comprising adding salt to the sample before evaporating the photoresist residue, wherein the salt includes sodium chloride (NaCl), potassium chloride (KCl), calcium chloride (CaCl₂), magnesium chloride (MgCl₂), or a combination thereof.

7. The method as claimed in claim 5, wherein the heating of the sample is performed at a temperature of about 60° C. to about 95° C.

8. The method as claimed in claim 5, wherein the analyzing of the evaporated photoresist residue includes:
adsorbing the evaporated photoresist residue on an adsorbent; and
analyzing the photoresist residue adsorbed on the adsorbent using a thermal desorption gas chromatography/mass spectrometry (TD-GC/MS) analysis method.

9. The method as claimed in claim 8, wherein the adsorbing of the evaporated photoresist residue on the adsorbent is performed using a quartz tube filled with the adsorbent, or a fiber coated with the adsorbent.

10. The method as claimed in claim 8, wherein the TD-GC/MS analysis method includes:
desorbing the photoresist residue adsorbed on the adsorbent; and
injecting the desorbed photoresist residue into a column.

11. The method as claimed in claim 10, wherein the desorbing of the photoresist residue includes heating the adsorbent on which the photoresist residue is adsorbed at a temperature of about 200° C. to about 300° C.

12. The method as claimed in claim 10, wherein the TD-GC/MS analysis method includes supplying a carrier gas of about 1.5 ml/min into the column, and controlling the column to raise the temperature by a predetermined temperature per minute from an initial temperature of about 40° C. to a final temperature of about 270° C.

13. The method as claimed in claim 5, wherein the analyzing of the evaporated photoresist residue is performed using a headspace gas chromatography/mass spectrometry (HS-GC/MS) analysis method, and wherein the HS-GC/MS analysis method includes injecting the evaporated photoresist residue into a column via a pipe heated to a temperature of about 110° C. to about 140° C.

14. A plating method, comprising:
supplying a first plating solution into a plating bath;
immersing a first substrate having a first lower metal interconnection and a first photoresist pattern in the first plating solution, the first photoresist pattern having an opening exposing the first lower metal interconnection;
performing a first plating process and forming a first plating pattern on the first lower metal interconnection exposed in the opening;
removing the first substrate from the first plating solution;
collecting a first sample of the first plating solution;
analyzing a residue of the first photoresist pattern included in the first sample;
performing at least one of exchanging, regenerating or supplementing the first plating solution to provide a second plating solution in the plating bath; and
immersing a second substrate having a second lower metal interconnection and a second photoresist pattern in the second plating solution, and performing a second plating process.

15. The method as claimed in claim 14, further comprising: after performing the second plating process,
collecting a second sample of the second plating solution;
analyzing a residue of the second photoresist pattern included in the second sample; and
performing at least one of exchanging, regenerating or supplementing the second plating solution to provide a third plating solution in the plating bath.

16. A plating method, comprising:
immersing a first substrate in a plating bath including a first plating solution, the first substrate including a photoresist pattern and a metal interconnection;
performing a first plating process and forming a first plating pattern on the first substrate;
removing the first substrate from the first plating solution;
analyzing a sample of the first plating solution and determining whether a content of a photoresist residue in the sample exceeds a preset reference value;
performing at least one of exchanging, regenerating or supplementing the first plating solution to provide a second plating solution in the plating bath if the content of the photoresist residue in the sample exceeds the preset reference value and maintaining the first plating solution in the plating bath if the content of the photoresist residue in the sample does not exceed the preset reference value;
immersing a second substrate in the plating bath, the plating bath including the first plating solution or the second plating bath according to whether the first plating solution is exchanged, regenerated or supplemented to provide the second plating solution or is maintained in the plating bath; and
performing a second plating process and forming a second plating pattern on the second substrate.

17. The plating method as claimed in claim 16, wherein:
the photoresist pattern includes an acrylic resin, and
the analyzing of the sample of the first plating solution to determine whether a content of a photoresist residue in the sample exceeds the preset reference value includes determining whether a content of an acrylic resin or acrylic resin residue in the sample exceeds the preset reference value.

18. The plating method as claimed in claim 16, wherein:
the acrylic resin of the photoresist pattern is an acrylic resin that decomposes to form at least one of ethyl cyclohexene, ethyl cyclopentene, methyl adamantane, ethyl adamantane or 4-hydroxy butyrolactone as a photoresist residue, and
the determining of whether the content of a photoresist residue in the sample exceeds the preset reference value includes determining whether a content of at least one of ethyl cyclohexene, ethyl cyclopentene, methyl adamantane, ethyl adamantane or 4-hydroxy butyrolactone exceeds the preset reference value.
